(19) United States
(12) Patent Application Publication
(10) Pub. No.: US 2005/0270407 A1
(43) Pub. Date: Dec. 8, 2005

(54) Imaging apparatus

(75) Inventor: Yoshihiro Yamaguchi, Asaka-shi (JP)

Correspondence Address: BIRCH STEWART KOLASCH & BIRCH, PO BOX 747, FALLS CHURCH, VA, 22040-0747, US

(73) Assignee: Fuji Photo Film Co., Ltd.

(21) Appl. No.: 11/140,739

(22) Filed: Jun. 1, 2005

(30) Foreign Application Priority Data
Jun. 2, 2004 (JP) 2004-164519

(51) Int. Cl. H04N 5/232

(52) U.S. Cl. 348/345; 235/375; 396/310; 396/373

(57) ABSTRACT

An imaging apparatus, comprising a receiving unit which receives a radio signal from an IC tag attached to a subject, a read unit which reads IC tag information recorded on an IC tag from each received radio signal, an image pickup unit which captures the subject and a first storage unit which stores IC tag information read from the IC tag and an image captured by the image pickup unit after associating the information with the image.

### BACKGROUND OF THE INVENTION

1. Field of the Invention

The present invention relates to an imaging apparatus, and more specifically to an imaging apparatus capable of associating the information about an IC tag attached to a subject with a captured subject image.

2. Related Art

Recently a very small device containing an integrated circuit with memory called an IC tag and an antenna for wireless communications has been developed. An IC tag is used in managing articles by attaching it as a tag to various articles. For example, according to Japanese Patent Application Laid Open No. 2004-72146, an image record area is provided around the center of an instant film inserted to a digital still camera (DSC) having a built-in printer, an enclosing unit which encloses a development and fixing agents is provided at one end of it, and an agent receiver is provided at the other end of it. The printer included in the DSC records an image in the image recording area, and develops and fixes the image. Then, the information about the storage position of the data of the recorded images, the thumbnail image data, and the capture information are written to the IC tag. That is, the image recorded on the recording material can be associated with the storage position of the image data.

### SUMMARY OF THE INVENTION

A method of managing an article by shooting it as a subject and using a shot image is effective. However, when an article with an IC tag attached to it is shot, it is necessary to manage information read from the IC tag together with an image recorded on the recording material. However, the technology of Japanese Patent Application Laid Open No. 2004-72146 only associates an image recorded on a recording material with the information such as the storage position of image data, etc. Thus, the correspondence between the information read from the IC tag and the image of an article cannot be obtained. The present invention has been developed to solve the above-mentioned problems and aims at providing an imaging apparatus capable of associating the information read from an IC tag attached to a subject with an image obtained by capturing the subject.

To solve the above-mentioned problems, the first aspect of the present invention provides an imaging apparatus including: a receiving unit which receives a radio signal from an IC tag attached to a subject; a read unit which reads IC tag information recorded on an IC tag from each received radio signal; an image pickup unit which captures a subject; and a first storage unit which stores IC tag information read from an IC tag and an image captured by the image pickup unit after associating the information with the image.

According to the invention, an image of an article as a subject can be associated with IC tag information recorded on the IC tag attached to the article.

The second aspect of the present invention provides the imaging apparatus based on the first aspect further including an intensity detection unit which detects intensity of each received radio signal, and the first storage unit stores intensity information obtain by associating IC tag information read from each IC tag with intensity of a radio signal from each IC tag.

According to the invention, the IC tag information can be associated with the intensity of a radio signal.

The third aspect of the present invention provides the imaging apparatus based on the second aspect further including a second storage unit which stores intensity distance correspondence information prescribing correspondence between intensity of a radio signal from an IC tag and a distance to an IC tag.

The fourth aspect of the present invention provides the imaging apparatus based on the third aspect in which the first storage unit stores distance information obtained by associating IC tag information read from each IC tag with a distance corresponding to intensity of a radio signal from each IC tag according to the intensity distance correspondence information.

According to the invention, the IC tag information can be associated with the difference to the article.

The fifth aspect of the present invention provides the imaging apparatus based on the third or fourth aspect, further including: a distance-measuring unit which measures a distance to a main subject on which the image pickup unit obtains focus; and a designation unit which designates main IC tag information recorded on an IC tag of the main subject according to a distance to the main subject, the intensity distance correspondence information, and the intensity information.

According to the invention, the IC tag information recorded on the IC tag of the subject on which focus is gained can be designated.

The sixth aspect of the present invention provides the imaging apparatus based on the fifth aspect in which the distance-measuring unit is a distance-measuring sensor.

The seventh aspect of the present invention provides the imaging apparatus based on the fifth aspect in which the distance-measuring unit detects a focal evaluation value indicating sharpness of a subject image based on a high frequency component in a signal output by an image pickup element, and measures a distance to a main subject based on a focal length of a lens having the focal evaluation value as an extreme value.

The eighth aspect of the present invention provides the imaging apparatus according to any of the fifth to seventh aspect, further including a position detection unit which detects a position of the main subject. The first storage unit stores the main IC tag information and the position of the main subject after associating the information with the position.

According to the invention, the IC tag information recorded on the IC tag of the main subject can be associated with the position of the main subject.

The ninth aspect of the present invention provides the imaging apparatus based on the first to eighth aspect in which the first storage unit is an image file recording an image captured by the image pickup unit.

The tenth aspect of the present invention provides the imaging apparatus based on the ninth aspect in which IC tag information read from an IC tag is stored in a header portion of the image file.

According to the invention, the image of an article as a subject can be associated with the IC tag information recorded on the IC tag attached to the article.

### BRIEF DESCRIPTION OF THE DRAWINGS

FIG. 1 is a block diagram of the digital camera according to the preferred embodiments of the present invention;

FIG. 2 is a flowchart of the process performed by the digital camera according to the first embodiment of the present invention;

FIGS. 3A to 3D are explanatory views showing the concept of intensity information, intensity distance correspondence information, main subject information, and distance information; and

FIG. 4 shows an example of a through image of an article as a subject to which an IC tag is attached.

### DETAILED DESCRIPTION OF THE PREFERRED EMBODIMENTS

The preferred embodiments of the present invention are explained below by referring to the attached drawings.

### First Embodiment

[Outline of the Configuration]

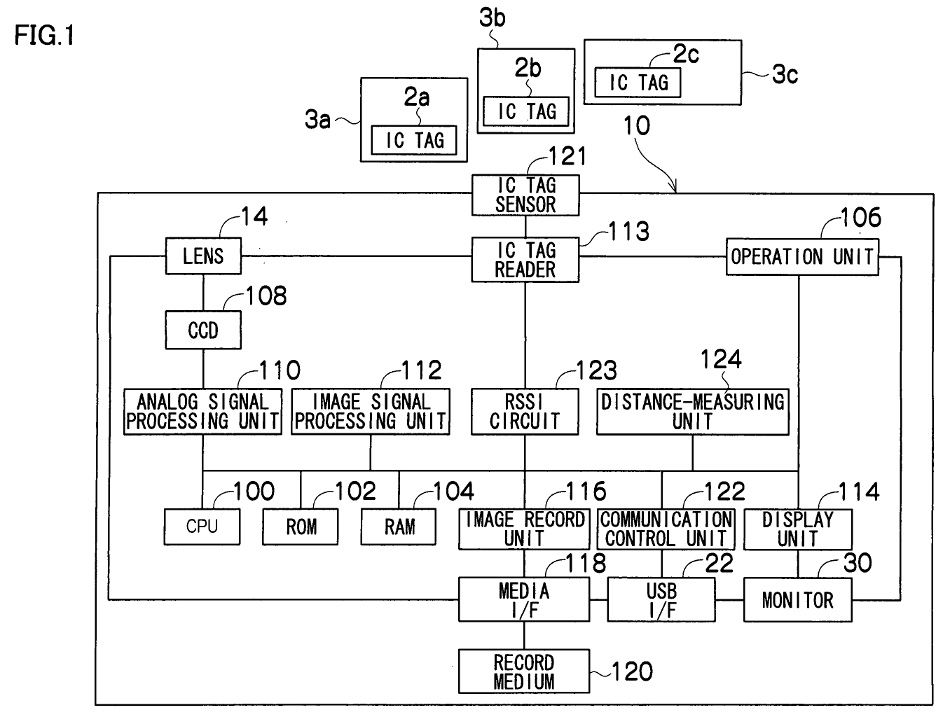

FIG. 1 is a block diagram showing an outline of the configuration of a digital camera 10 according to the preferred embodiments of the present invention. In FIG. 1, a CPU 100 is a control unit for centrally controlling each circuit of the present camera system, and comprises ROM 102, RAM 104, etc. The ROM 102 stores a program, various types of data, etc. required for control by the CPU 100. The RAM 104 is used as a work area in performing various arithmetic operations, etc. by the CPU 100. The ROM 102 is configured by flash ROM capable of erasing/writing data.

The CPU 100 controls the operation of a corresponding circuit based on an operation signal output from an operation unit 106 comprising a release button, a power source button, a strobe button, a macro button, a zoom lever, a display button, a BACK button, a mark button, a menu/OK button, a cross button, a mode switch, etc., performs lens drive control, shooting operation control, image processing control, image data record/regeneration control, display-control of the monitor 30, etc., and performs various arithmetic operations such as an automatic exposure (AE) operation, an automatic focusing (AF) operation, a white balance (WB) adjusting operation, etc.

The light passing through a lens 14 enters a CCD image sensor (CCD) 108. On the photoreceiving surface of the CCD 108, a photosensor is arranged in a two-dimensional array and an optical image of a subject formed on the photoreceiving surface of the CCD 108 through the lens 14 is converted to a signal charge of an amount depending on the amount of incident light by each photosensor. The signal charge accumulated in each photosensor is sequentially read as a voltage signal (image signal) depending on the signal charge based on the drive pulse applied by a timing generator not shown in the attached drawings, and transmitted to an analog signal processing unit 110.

The analog signal processing unit 110 includes a signal processing circuit such as a sampling hold circuit, a color separating circuit, a gain adjusting circuit, an A/D converter, etc. An image signal input by the analog signal processing unit 110 is treated in the correlating double sampling and treated in the color separating process into each of the color signals R, G, and B. The signal level of each color signal is adjusted (pre-white-balance process). Then, the signal is converted to a digital image signal and stored in the RAM 104.

The image signal stored in the RAM 104 is transmitted to an image signal processing unit 112. The image signal processing unit 112 is configured by a digital signal processor (DSP) including a brightness/color difference signal generation circuit, a gamma correction circuit, a sharpness correction circuit, a contrast correction circuit, a white balance correction circuit, etc., and processes an image signal input at a command from the CPU 100. The image signal input to the image signal processing unit 112 is converted to a brightness signal (Y signal) and a color difference signal (Cr, Cb signal), treated in a predetermined process such as gamma correction, etc., and then stored in the RAM 104. The image data stored in the RAM 104 is input to a display unit 114. The display unit 114 converts input image data to a signal in a predetermined system for display (for example, a color composite video signal in an NTSC system), and outputs a resultant signal to a monitor 30.

The image data in the RAM 104 is periodically re-written according to the image signal output from the CCD 108, and the video signal generated from the image data is provided for the monitor 30, thereby displaying the image input through the CCD 108 on the monitor 30 in real time. A shooter can confirm the angle of view by the image (through image) displayed on the monitor 30.

The display unit 114 includes an OSD signal generation circuit. The OSD signal generation circuit generates a signal for display of a character and symbol information such as a shutter speed, a diaphragm value, a possible number of images to be taken, a shooting date, a warning message, an autofocus frame (AF), etc. The signal output from the OSD signal generation circuit is mixed to an image signal as necessary, and provided for the monitor 30. Thus, a composite image from a through image, a regenerated image, characters, etc. can be displayed.

When the mode of a camera is set in a shooting mode by a mode switch, the digital camera 10 enters a shooting state. If the release button is half pressed in this state, an S1ON signal is sent to the CPU 100. The CPU 100 detects the S1ON signal, and performs AE and AF operations. That is, the CPU 100 controls a lens drive unit not shown in the attached drawings to focus the subject, measures the brightness of a subject, and determines the diaphragm value and the shutter speed for the optimum exposure.

When the release button is fully pressed, an S2ON signal is issued to the CPU 100. The CPU 100 detects the S2ON signal, and performs a recording operation. That is, the diaphragm drive unit not shown in the attached drawings and the electronic shutter of the CCD 108 are controlled such that the diaphragm value and the shutter speed determined when the release button is half pressed can be obtained, thereby fetching an image.

Thus, in cooperation with the operation with the fully pressed release button, fetching image data for recording is started, and an image signal for one frame output from the CCD 108 is fetched to the RAM 104 through the analog signal processing unit 110. An image signal fetched to the RAM 104 is first treated in a predetermined signal processing operation by the image signal processing unit 112, stored in the RAM 104, and transmitted to an image record unit 116.

The image record unit 116 includes a compressing/decompressing circuit, and the compressing/decompressing circuit compresses image data input at a command from the CPU 100 in a predetermined system such as JPEG, etc. The compressed image data is recorded on a record medium 120 as an image file (for example, an image file in an Exif format (exchangeable image file format)) in a predetermined format through a media I/F (media I(F) 118. Furthermore, the record medium 120 can be an xD picture card, smart media, compact flash, a magnetic disk, an optical disk, a magneto-optic disk, a memory stick, etc. which are removable media to a camera body, and other record media built in a camera body including an internal memory, etc.

When a regeneration mode is selected by a mode switch, an image recorded on the record medium 120 can be regenerated. When the mode switch is set in the regeneration mode, the image data of the image file recorded last in the record medium 120 is read. The read image data is treated in a predetermined decompressing process by the image record unit 116, and output to the monitor 30 through the display unit 114. Thus, the image recorded on the record medium 120 can be browsed.

The frame advance of an image is performed by a cross button. When the right key of the cross button is pressed, the next image file is read from the record medium 120 and regenerated and displayed on the monitor 30. When the left key of the cross button is pressed, the preceding image file is read from the record medium 120, and regenerated and displayed on the monitor 30.

The digital camera 10 transfers the operation mode to a communication mode by the trigger of the USB connection to the host equipment. The communication mode can be a “PC mode” in which connection is made to a personal computer (PC), and the PC recognizes a removable disk (mass-storage device), and a “direct print mode” in which connection is made to a printer, and an image recorded on the record medium 120 is printed on the printer. A communication control unit 122 transmits and receives data in a predetermined command format in the set communication mode.

The camera body of the digital camera 10 is provided with an IC tag sensor 121 with an antenna having the forward directivity of the lens 14, and receives and detects a radio signal transmitted from one or more IC tags 2 (three IC tags 2a to 2c as an example in FIG. 1) attached to one or more articles 3. An electromagnetic shield film, etc. can be applied backward the lens 14 of the IC tag sensor 121 to prevent the IC tag sensor 121 from receiving the radio signal from the IC tag 2 backward the lens 14. An RSSI circuit 123 detects the intensity of the radio signal received by the IC tag sensor 121, and outputs it to the CPU 100. An IC tag reader 113 reads information (hereinafter referred to as IC tag information) recorded on the IC tag 2 from the radio signal received by the IC tag sensor 121, and outputs it to the CPU 100. A distance-measuring unit 124 is a device which measures the distance to the subject on which focus is obtained. For example, it is a device in which an AF evaluation value (focal evaluation value) indicating the sharpness of a subject image based on the high frequency component in the signal output from the CCD 108 is detected, and the distance from the lens position to the subject image when the focal position of the lens is set such that the focal evaluation value can be the extreme value is calculated. Otherwise, it may be a triangular distance-measuring sensor which receives the light emitted to the subject on which focal is obtained and returned after reflected by the subject, to detect the distance to a subject based on the angle made by a light emitting unit and a photoreceiving unit.

[Process Performed By Digital Camera]

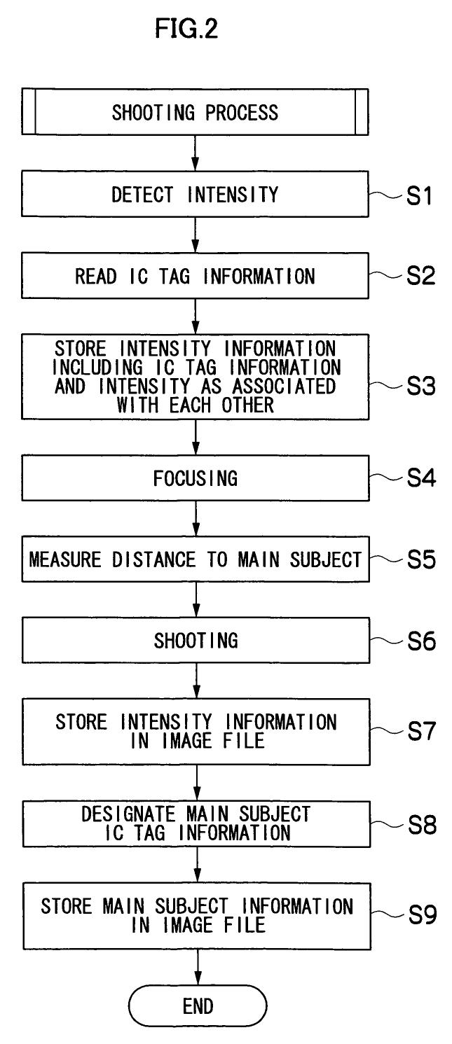

The flow of the shooting process performed by the digital camera 10 is explained below by referring to the flowchart shown in FIG. 2. In this process, the IC tag information on an IC tag 2 attached to an article 3 as a subject of the digital camera 10 is stored in the header portion of the image file obtained by shooting the article 3. The process is started when the IC tag sensor 121 detects the radio signal of the IC tags 2a to 2c.

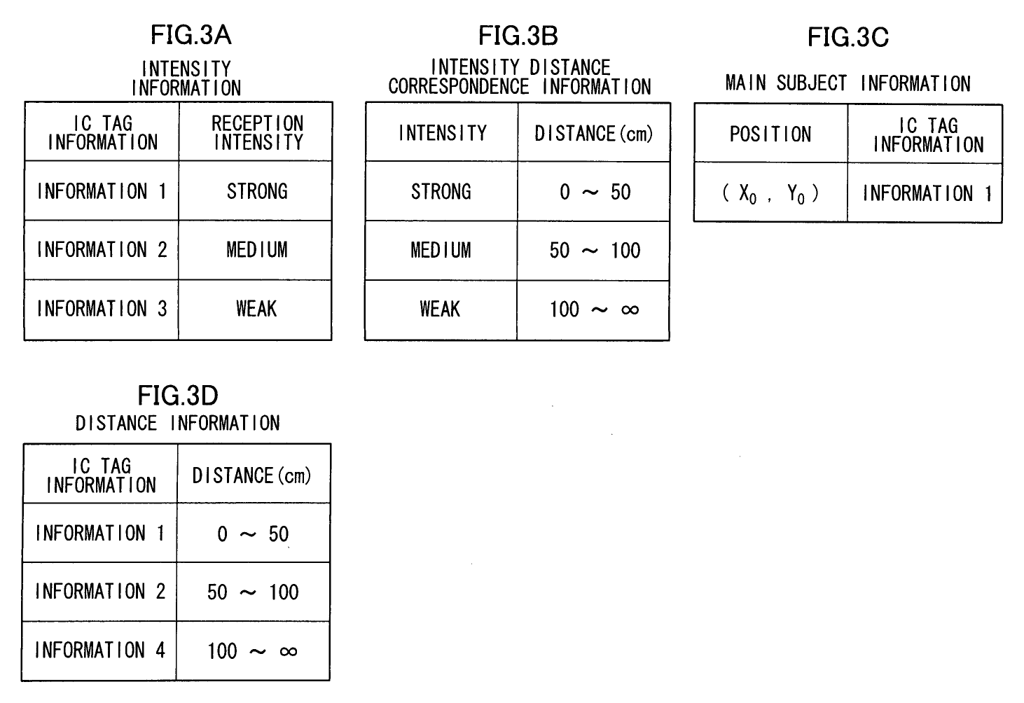

In S1, the RSSI circuit 123 detects the intensity of the radio signal transmitted from the IC tags 2a to 2c, and outputs it to the CPU 100. In S2, the IC tag reader 113 reads the IC tag information from the radio signal of the IC tag 2. In S3, the CPU 100 stores the intensity information obtained by associating the intensity detected in S1 with the IC tag information read from each IC tag 2 in S2 in the RAM 104. FIG. 3A shows an example of intensity information. As shown in FIG. 3A, in the intensity information, the information 1 to 3 which is the IC tag information read from the IC tags 2a to 2c respectively attached to the articles 3a to 3c is associated with the intensity of the radio signal read from the information 1 to 3. That is, by comparing the distance of the article 3 in the image with the intensity of the intensity information, the correspondence between the article 3 as a subject and the IC tag information can be indicated.

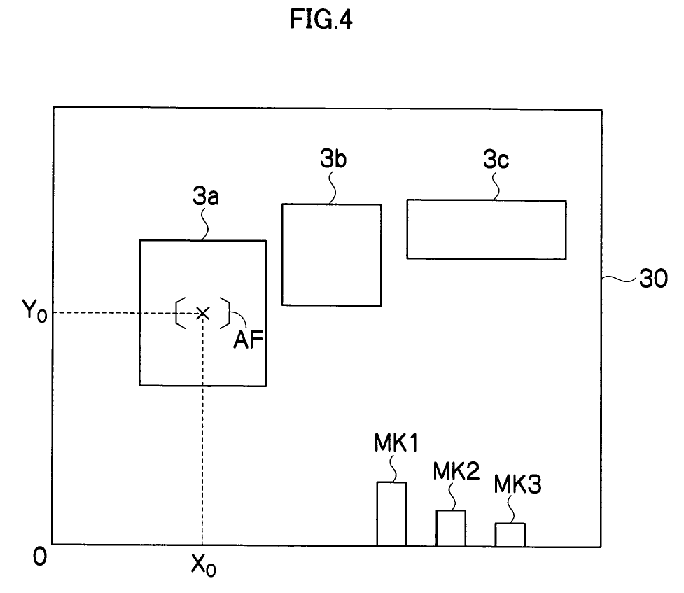

In S4, the half-pressed operation of the shutter button of the operation unit 106 is detected, and when it is detected, focus lock (lock of focus, focusing) is performed on the subject (that is, the article 3) in the shooting position encompassed by the autofocus frame AF. Hereinafter, the focus locked article 3 can be represented as a main subject. FIG. 4 shows an example of a focus locked through image and a display of the autofocus frame AF. In this figure, when the autofocus frame AF is positioned at the subject 3a and operated by a half-pressed state, and focus is obtained on the article 3a. The display position on the monitor 30 of the autofocus frame AF can be at the center of the monitor 30, or can be transferred to an optional position (for example, the position moved to somewhat the left from the center point on the monitor 30 as shown in FIG. 4) by scrolling up and down, and right and left with the cross button. After this, by half pressing the shutter button, focus lock can be set on the subject in the shooting position shown by the moved autofocus frame AF. Hereinafter, the shooting position indicated by the autofocus frame AF after focusing is referred to as the main subject position.

FIG. 4 shows, as an example of the main subject position, the central position (X0, Y0) of the autofocus frame AF focus locked on the XY plane on the monitor 30 having the origin 0 at the lower left corner of the monitor 30. That is, the position of the article 3 focused in the main subject position can be obtained. By the OSD signal generation circuit, the detection of the IC tag 2, and the marker indicating the intensity of the radio signal transmitted by the detected IC tag can be displayed on the monitor 30. In FIG. 4, the markers MK1 to MK3 indicating the intensity of the radio signal transmitted by three IC tags 2a to 2c are displayed on the monitor 30.

In S5, the distance-measuring unit 124 calculates the distance to the main subject. For example, as shown in FIG. 4, when the focus lock occurs on the article 3a, the distance to the article 3a is calculated. In S6, according to the detection that the shutter button is fully pressed, fetching image data is started for recording. The image data for recording is recorded on the data portion of the image file in a predetermined format. In S7, the CPU 100 stores the intensity information about the RAM 104 in the header portion of the image file. As an example, when the image file has a tag in the header portion in the Exif format, a predetermined tag (UserComment tag, etc.) can store intensity information.

In S8, the CPU 100 designates the intensity of the radio signal corresponding to the distance to the main subject based on the intensity distance correspondence information stored in the ROM 102. FIG. 3B shows an example of the intensity distance correspondence information. The intensity distance information prescribes the correspondence between the distance from the distance-measuring unit 124 to the IC tag 2 and the intensity of the radio signal transmitted by the IC tag 2. As an example, in FIG. 3B, the intensity “strong” corresponds to the distance “0-50 cm (0 cm or more, and less than 50 cm)”, the intensity “medium” corresponds to the distance “50-100 cm (50 cm or more, and less than 100 cm)”, and the intensity “weak” corresponds to the distance “100 cm-∞ (100 cm or more)”. However, the prescription of the correspondence between the distance and the intensity by the intensity distance correspondence information is not limited to the description above, but any equation indicating the proportional expression between the distance and the intensity can be accepted. The CPU 100 can designate the IC tag information corresponding to the intensity of the radio signal designated as described above according to the intensity information, thereby designating the IC tag information on the main subject which is the IC tag information recorded on the IC tag 2 attached to the main subject. Then, the CPU 100 stores the main subject information in which the main subject IC tag information is associated with the main subject position in the header portion of the image file. FIG. 3C shows an example of main subject information. In FIG. 3C, the subject position (X0, Y0) of the article 3a on which focus is gained corresponds to the information 1 (that is, the main subject IC tag information) read from the tag 2a attached to the article 3a. When the main subject information is compared with the image, the relationship between the position of the article 3 on which focus is obtained in the image and the IC tag information about the article 3 can be recognized.

### Second Embodiment

The present invention can be applied to a silver salt camera not provided with an image pickup element such as a CCD 108. For example, as in the first embodiment, the silver salt camera can be provided with the IC tag sensor 121, the IC tag reader 113, the CPU 100, the ROM 102, the RAM 104, and the operation unit 106. While the fully pressed shutter button of the operation unit 106 stores an image on the silver salt film, the information in which the frame number of the image is associated with the IC tag information is stored in a magnetic film, a semiconductor storage device, etc., thereby associating the shot image through the frame number with the IC tag information read from the IC tag. The silver salt camera can be further provided with the RSSI circuit 123, thereby detecting the intensity of the received radio signal from the IC tag 2, and recording the detected intensity as associated with the frame number. Otherwise, the silver salt camera can be further provided with the distance-measuring unit 124 such as a triangular distance-measuring sensor, etc. to measure the distance to the main subject on which focus is obtained, and the IC tag information recorded on the IC tag 2 attached to the main subject can be designated based on the intensity distance correspondence information stored in the ROM 102, the measured distance and the intensity of the radio signal from the IC tag 2.

### Other Embodiments

(1) As described in the first embodiment, no RSSI circuit 123 or distance-measuring unit 124 are provided in the digital camera 10, the ROM 102 does not store the intensity distance correspondence information, but the IC tag information is stored in the header portion of the image file, and the image data is stored in the data portion. Thus, the image of the article 3 as a subject can correspond to the IC tag information of the IC tag 2 attached to the article 3.

(2) Instead of recording the intensity information in the image file, the correspondence between the IC tag information and the distance determined through the intensity contained in the intensity information and the intensity contained in the intensity distance correspondence information can be recorded as distance information in the image file. FIG. 3D shows an example of distance information. Since the IC tag information corresponds to the distance of the article 3 in the distance information, it is determined from the distance of the article 3 which IC tag information corresponds to the plurality of articles 3 in the image. Furthermore, the distance of the article 3 on which focus is obtained is measured by the distance-measuring unit 124, and the distance information can be compared with the measured distance, thereby designating the IC tag information corresponding to the main subject.

(3) The above-mentioned intensity information, distance information and main subject information can be combined as character data with image data, and stored in the data portion of the image file.

1. An imaging apparatus, comprising:
a receiving unit which receives a radio signal from an IC tag attached to a subject;
a read unit which reads IC tag information recorded on an IC tag from each received radio signal;
an image pickup unit which captures the subject; and
a first storage unit which stores IC tag information read from the IC tag and an image captured by the image pickup unit after associating the information with the image.

2. The imaging apparatus according to claim 1, further comprising:
an intensity detection unit which detects intensity of each received radio signal, wherein
the first storage unit stores intensity information obtain by associating the IC tag information read from each IC tag with intensity of a radio signal from each IC tag.

3. The imaging apparatus according to claim 2, further comprising:
a second storage unit which stores intensity distance correspondence information prescribing correspondence between intensity of the radio signal from the IC tag and a distance to the IC tag.

4. The imaging apparatus according to claim 3, wherein
the first storage unit stores distance information obtained by associating IC tag information read from each IC tag with a distance corresponding to intensity of the radio signal from each IC tag according to the intensity distance correspondence information.

5. The imaging apparatus according to claim 3, further comprising:
a distance-measuring unit which measures a distance to a main subject on which the image pickup unit obtains focus; and
a designation unit which designates main IC tag information recorded on an IC tag of the main subject according to a distance to the main subject, the intensity distance correspondence information, and the intensity information.

6. The imaging apparatus according to claim 4, further comprising:
a distance-measuring unit which measures a distance to a main subject on which the image pickup unit obtains focus; and
a designation unit which designates main IC tag information recorded on an IC tag of the main subject according to a distance to the main subject, the intensity distance correspondence information, and the intensity information.

7. The imaging apparatus according to claim 5, wherein
the distance-measuring unit is a distance-measuring sensor.

8. The imaging apparatus according to claim 6, wherein
the distance-measuring unit is a distance-measuring sensor.

9. The imaging apparatus according to claim 5, wherein
the distance-measuring unit detects a focal evaluation value indicating sharpness of a subject image based on a high frequency component in a signal output by an image pickup element, and measures a distance to a main subject based on a focal length of a lens having the focal evaluation value as an extreme value.

10. The imaging apparatus according to claim 6, wherein
the distance-measuring unit detects a focal evaluation value indicating sharpness of a subject image based on a high frequency component in a signal output by an image pickup element, and measures a distance to a main subject based on a focal length of a lens having the focal evaluation value as an extreme value.

11. The imaging apparatus according to claim 5, further comprising:
a position detection unit which detects a position of the main subject, wherein
the first storage unit stores the main IC tag information and the position of the main subject after associating the information with the position.

12. The imaging apparatus according to claim 6, further comprising:
a position detection unit which detects a position of the main subject, wherein
the first storage unit stores the main IC tag information and the position of the main subject after associating the information with the position.

13. The imaging apparatus according to claim 7, further comprising:
a position detection unit which detects a position of the main subject, wherein
the first storage unit stores the main IC tag information and the position of the main subject after associating the information with the position.

14. The imaging apparatus according to claim 8, further comprising:
a position detection unit which detects a position of the main subject, wherein
the first storage unit stores the main IC tag information and the position of the main subject after associating the information with the position.

15. The imaging apparatus according to claim 9, further comprising:
a position detection unit which detects a position of the main subject, wherein
the first storage unit stores the main IC tag information and the position of the main subject after associating the information with the position.

16. The imaging apparatus according to claim 10, further comprising:
a position detection unit which detects a position of the main subject, wherein
the first storage unit stores the main IC tag information and the position of the main subject after associating the information with the position.

17. The imaging apparatus according to claim 1, wherein
the first storage unit is an image file recording an image captured by the image pickup unit.

18. The imaging apparatus according to claim 17, wherein
IC tag information read from the IC tag is stored in a header portion of the image file.
